(19) United States
(12) Patent Application Publication
(10) Pub. No.: US 2012/0086690 A1
(43) Pub. Date: Apr. 12, 2012

(54) PLASMA DISPLAY PANEL DRIVE METHOD AND PLASMA DISPLAY DEVICE

(75) Inventor: Yutaka Yoshihama, Osaka (JP)

(73) Assignee: PANASONIC CORPORATION, Osaka (JP)

(21) Appl. No.: 13/375,324

(22) PCT Filed: Jun. 7, 2010
(86) PCT No.: PCT/JP2010/003778

§ 371 Date: Nov. 30, 2011

(30) Foreign Application Priority Data
Jun. 8, 2009 (JP) 2009-136969
Jun. 10, 2009 (JP) 2009-138881

(51) Int. Cl. G09G 3/28; G06F 3/038

(52) U.S. Cl. 345/210; 345/67

(57) ABSTRACT

Forced initializing operation is omitted while address operation is performed stably, light emission related to no gradation display is eliminated, and the contrast is largely improved. In an erasing period, erasing discharge is selectively caused only in the discharge cell having undergone address discharge in the immediately preceding address period. It is assumed that first voltage is derived by subtracting voltage applied to a data electrode from low-side voltage of a sustain pulse, second voltage is derived by subtracting voltage applied to the data electrode from high-side voltage of the sustain pulse, and third voltage is derived by subtracting low-side voltage of an address pulse applied to the data electrode from low-side voltage of a scan pulse. The voltage derived by subtracting the third voltage from the first voltage is not lower than a discharge start voltage w here t he data electrode is used as the positive electrode and the scan electrode is used as the negative electrode. The voltage derived by subtracting the third voltage from the second voltage does not exceed the sum of a discharge start voltage where the data electrode is used as the positive electrode and the scan electrode is used as the negative electrode and a discharge start voltage where the data electrode is used as the negative electrode and the scan electrode is used as the positive electrode.

### TECHNICAL FIELD

The present invention relates to a driving method for an alternating current plasma display panel, and a plasma display apparatus.

### BACKGROUND ART

A plasma display panel (hereinafter referred to as “panel”) has a plurality of discharge cells having a scan electrode, a sustain electrode, and a data electrode. The plasma display panel excites respective phosphors of red, green, and blue to emit light with ultraviolet rays generated by gas discharge in the discharge cells, and thus provides color display.

A subfield method is generally used as a method of driving the panel. In this method, one field is formed of a plurality of subfields including an initializing period, an address period, and a sustain period, and the subfields in which light is emitted are combined, thereby performing gradation display. In each subfield, the initializing operation is performed in the initializing period, the address operation is performed in the address period, and the sustain operation is performed in the sustain period. The initializing operation causes initializing discharge, and produces wall charge required for the subsequent address operation. The initializing operation includes a forced initializing operation of causing initializing discharge regardless of the operation of the immediately preceding subfield, and a selective initializing operation of selectively causing initializing discharge in the discharge cell that has undergone address discharge in the immediately preceding subfield. The address operation selectively causes address discharge in a discharge cell according to an image to be displayed to produce wall charge. The sustain operation alternately applies sustain pulses to a display electrode pair to cause sustain discharge, and emits light in a phosphor layer in the corresponding discharge cell. The light emission in the phosphor layer by this sustain discharge is related to gradation display, and the other light emission is not related to the gradation display.

A driving method has been studied in which the luminance (hereinafter referred to as “luminance of black level”) is reduced in displaying black as the lowest gradation in the subfield method, the light emission that is not related to the gradation display is reduced as much as possible, and the contrast is improved. For example, Patent Literature 1 discloses a driving method in which the number of forced initializing operations is set to one per field and the forced initializing operation is performed using a gently varying ramp waveform voltage.

Patent Literature 2 discloses a driving method in which a display electrode pair is divided into n, the number of forced initializing operations is set to one for n fields, the light emission that is not related to the gradation display is further reduced to further reduce the luminance, and the contrast is further improved.

However, the forced initializing operation is performed even in the driving methods of Patent Literature 1 and Patent Literature 2, so that the light emission that is not related to the gradation display occurs. This means that light emission occurs even in a discharge cell for displaying black, and hence the improvement in contrast has limitations. In the forced initializing operation, the wall charge required for causing address discharge in the subsequent address period is accumulated, and priming for certainly causing the address discharge by shortening the discharge delay time is caused. Therefore, when the forced initializing operation is simply omitted, disadvantageously, normal image display is not allowed because the address discharge does not occur or the discharge delay time of the address discharge becomes excessively long to destabilize the address operation.

### Citation List

[Patent Literature]
[PTL 1]
Unexamined Japanese Patent Publication No. 2000-242224
[PTL 2]
Unexamined Japanese Patent Publication No. 2006-091295

### SUMMARY OF THE INVENTION

The present invention provides a driving method for a panel and a plasma display apparatus where a stable address operation is performed and the contrast is improved without using a forced initializing operation.

In the driving method for a panel of the present invention, one field is formed of a plurality of subfields having an address period, a sustain period, and an erasing period, and a panel that has a plurality of discharge cells having a scan electrode, a sustain electrode, and a data electrode is driven. In an erasing period, erasing discharge is selectively generated only in the discharge cell that has undergone address discharge in the immediately preceding address period. First voltage is assumed to be the voltage derived by subtracting the voltage applied to the data electrode from the low-side voltage of the sustain pulse applied to the scan electrode in the sustain period. Second voltage is assumed to be the voltage derived by subtracting the voltage applied to the data electrode from the high-side voltage of the sustain pulse applied to the scan electrode in the sustain period. Third voltage is assumed to be the voltage derived by subtracting the low-side voltage of the address pulse applied to the data electrode from the low-side voltage of the scan pulse applied to the scan electrode in the address period. The voltage derived by subtracting the third voltage from the first voltage is not lower than a discharge start voltage where the data electrode is used as the positive electrode and the scan electrode is used as the negative electrode. The voltage derived by subtracting the third voltage from second voltage does not exceed the sum of the discharge start voltage where the data electrode is used as the positive electrode and the scan electrode is used as the negative electrode and the discharge start voltage where the data electrode is used as the negative electrode and the scan electrode is used as the positive electrode. This method can provide a driving method for a panel where the forced initializing operation is omitted while the address operation is performed stably, the light emission that is not related to the gradation display is eliminated, and the contrast is largely improved.

In the driving method for the panel of the present invention, preferably, a voltage that is not less than the low-side voltage of the scan pulse and not more than the high-side voltage of the sustain pulse is applied to the scan electrode.

In the driving method for the panel of the present invention, preferably, the absolute value of the low-side voltage of the scan pulse is larger than the absolute value of the high-side voltage of the sustain pulse.

A plasma display apparatus of the present invention has the following elements:
a panel that has a plurality of discharge cells including a scan electrode, a sustain electrode, and a data electrode; and
a driver circuit that forms one field using a plurality of subfields having an address period, a sustain period, and an erasing period, generates a driving voltage waveform, and applies the waveform to each electrode of the panel.
   The driver circuit, in the erasing period, drives the panel by selectively causing the erasing discharge only in the discharge cell that has undergone address discharge in the immediately preceding address period. The driver circuit sets the following conditions:
the voltage derived by subtracting the third voltage from the first voltage is not lower than the discharge start voltage where the data electrode is used as the positive electrode and the scan electrode is used as the negative electrode; and
the voltage derived by subtracting the third voltage from second voltage does not exceed the sum of the discharge start voltage where the data electrode is used as the positive electrode and the scan electrode is used as the negative electrode and the discharge start voltage where the data electrode is used as the negative electrode and the scan electrode is used as the positive electrode.
   Here, the first voltage is assumed to be the voltage derived by subtracting the voltage applied to the data electrode from the low-side voltage of the sustain pulse applied to the scan electrode in the sustain period. The second voltage is assumed to be the voltage derived by subtracting the voltage applied to the data electrode from the high-side voltage of the sustain pulse applied to the scan electrode in the sustain period. The third voltage is assumed to be the voltage derived by subtracting the low-side voltage of the address pulse applied to the data electrode from the low-side voltage of the scan pulse applied to the scan electrode in the address period. This configuration allows a plasma display apparatus where the forced initializing operation is omitted while the address operation is performed stably, the light emission that is not related to the gradation display is eliminated, and the contrast is largely improved.

In a driving method for a panel of the present invention, a panel that has a plurality of discharge cells having a scan electrode, a sustain electrode, and a data electrode is driven, and one field is formed of a plurality of subfields. The subfields have an address period in which address discharge is caused by applying a scan pulse to the scan electrode and applying an address pulse to the data electrode, a sustain period in which sustain discharge is caused by alternately applying a sustain pulse corresponding to the luminance weight to the scan electrode and sustain electrode, and an erasing period in which erasing discharge is caused by applying a predetermined voltage to the scan electrode and sustain electrode. In the erasing period, erasing discharge is selectively caused only in the discharge cell that has undergone address discharge in the immediately preceding address period. The plurality of fields includes both a first field and a second field. In the first field, a scan pulse is sequentially applied to a plurality of arranged scan electrodes in the order from one-side scan electrode to the-other-side scan electrode in the address period of the subfield with the lowest luminance weight. In the second field, a scan pulse is sequentially applied to the plurality of arranged scan electrodes in the order from the-other-side scan electrode to one-side scan electrode in the address period of the subfield with the lowest luminance weight. This method can provide a driving method for a panel where the forced initializing operation is omitted while the discharge delay is shortened and the address operation is performed stably, the light emission that is not related to the gradation display is eliminated, and the contrast is largely improved.

Preferably, the driving method for the panel of the present invention alternately uses the first field and the second field.

A plasma display apparatus of the present invention has the following elements:
a panel that has a plurality of discharge cells including a scan electrode, a sustain electrode, and a data electrode; and
a driver circuit that forms one field using a plurality of subfields having an address period, a sustain period, and an erasing period, generates a driving voltage waveform, and applies the waveform to each electrode of the panel.
   In the address period, address discharge is caused by applying a scan pulse to the scan electrode and applying an address pulse to the data electrode. In the sustain period, sustain discharge is caused by alternately applying a sustain pulse corresponding to the luminance weight to the scan electrode and sustain electrode. In the erasing period, erasing discharge is caused by applying a predetermined voltage to the scan electrode and sustain electrode. In the erasing period, the driver circuit drives the panel by selectively causing the erasing discharge only in the discharge cell that has undergone address discharge in the immediately preceding address period. The plurality of fields includes both a first field and a second field. In the first field, a scan pulse is sequentially applied to a plurality of arranged scan electrodes in the order from one-side scan electrode to the-other-side scan electrode in the address period of the subfield with the lowest luminance weight. In the second field, a scan pulse is sequentially applied to the plurality of arranged scan electrodes in the order from the-other-side scan electrode to one-side scan electrode in the address period of the subfield with the lowest luminance weight. This configuration allows a plasma display apparatus where the forced initializing operation is omitted while the discharge delay is shortened and the address operation is performed stably, the light emission that is not related to the gradation display is eliminated, and the contrast is largely improved.

The present invention can provide a driving method for a panel and a plasma display apparatus where a stable address operation is performed and the contrast is improved without using the forced initializing operation.

### BRIEF DESCRIPTION OF DRAWINGS

FIG. 1 is an exploded perspective view of a panel used in a plasma display apparatus in accordance with a first exemplary embodiment of the present invention.

FIG. 2 is an electrode array diagram of the panel used in the plasma display apparatus.

FIG. 3 is a waveform chart of driving voltage to be applied to each electrode of the plasma display apparatus.

FIG. 4 is a diagram illustrating the definition of first voltage, second voltage, and third voltage.

FIG. 5 is a diagram showing one example of a method of easily measuring discharge start voltage.

FIG. 6 is a circuit block diagram of the plasma display apparatus in accordance with the first exemplary embodiment of the present invention.

FIG. 7 is a circuit diagram of a scan electrode driver circuit of the plasma display apparatus.

FIG. 8 is a circuit diagram of a sustain electrode driver circuit of the plasma display apparatus.

FIG. 9 is a circuit diagram of a data electrode driver circuit of the plasma display apparatus.

FIG. 10 is a waveform chart of driving voltage to be applied in a first field to each electrode of the plasma display apparatus in accordance with a second exemplary embodiment of the present invention.

FIG. 11 is a waveform chart of driving voltage to be applied in a second field to each electrode of the plasma display apparatus in accordance with the second exemplary embodiment of the present invention.

### DESCRIPTION OF EMBODIMENTS

Plasma display apparatuses in accordance with exemplary embodiments of the present invention will be described hereinafter with reference to the accompanying drawings.

### First Exemplary Embodiment

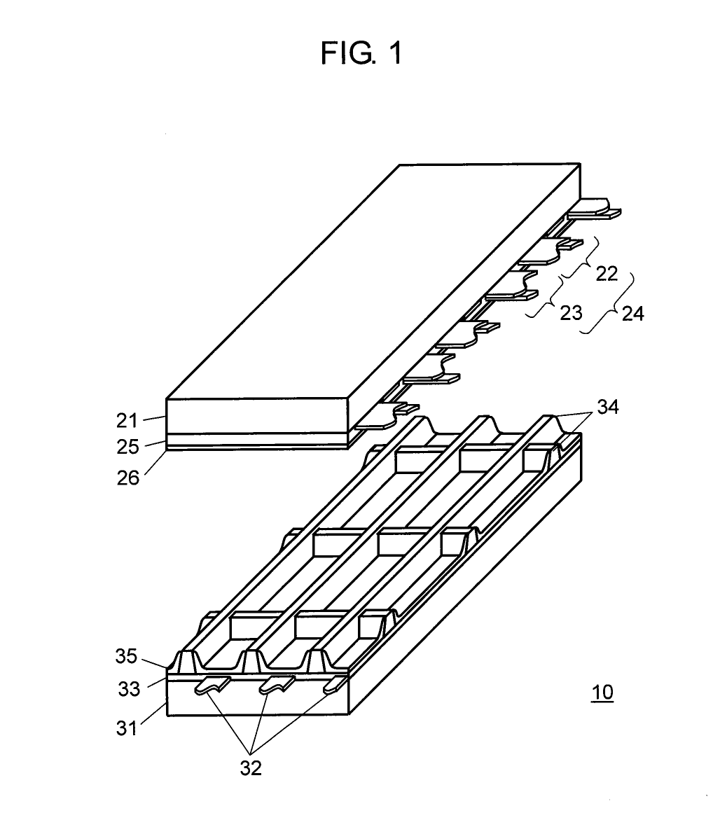

FIG. 1 is an exploded perspective view of panel 10 used in a plasma display apparatus in accordance with a first exemplary embodiment of the present invention. A plurality of display electrode pairs 24 formed of scan electrodes 22 and sustain electrodes 23 is disposed on glass-made front substrate 21. Dielectric layer 25 is formed so as to cover display electrode pairs 24, and protective layer 26 is formed on dielectric layer 25. Protective layer 26 is made of magnesium oxide, which is a material of high electron discharge performance, in order to facilitate the occurrence of discharge. A plurality of data electrodes 32 is formed on rear substrate 31, dielectric layer 33 is formed so as to cover data electrodes 32, and mesh barrier ribs 34 are formed on dielectric layer 33. Phosphor layers 35 for emitting lights of red, green, and blue are disposed on the side surfaces of barrier ribs 34 and on dielectric layer 33. As a red phosphor, a phosphor mainly containing (Y,Gd)BO₃:Eu is used, for example. As a green phosphor, a phosphor mainly containing Zn₂SiO₄:Mn is used, for example. As a blue phosphor, a phosphor mainly containing BaMgAl₁₀O₁₇:Eu is used, for example.

Front substrate 21 and rear substrate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example. The discharge space is partitioned into a plurality of sections by barrier ribs 34. Discharge cells are formed in the intersecting parts of display electrode pairs 24 and data electrodes 32. The discharge cells discharge and emit light to display an image.

The structure of panel 10 is not limited to the above-mentioned one, but may be a structure having striped barrier ribs, for example.

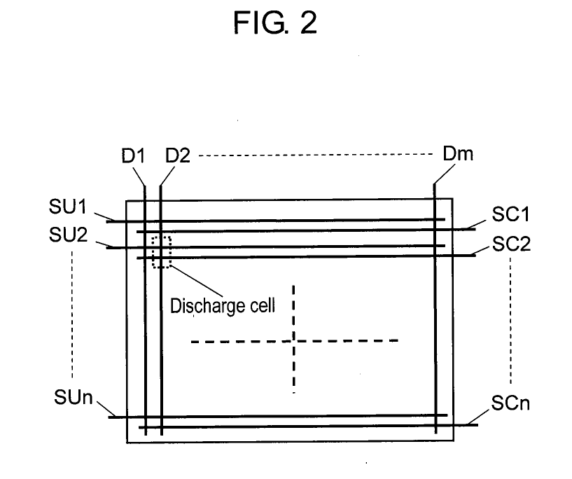

FIG. 2 is an electrode array diagram of panel 10 used in the plasma display apparatus in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both extended in the row direction, and m data electrode D1 through data electrode Dm (data electrodes 32 in FIG. 1) extended in the column direction. A discharge cell is formed in the part where a pair of scan electrode SCi (i is 1 through n) and sustain electrode SUi intersect with one data electrode Dj (j is 1 through m). Thus, m×n discharge cells are formed in the discharge space.

Next, a driving voltage waveform and operation for driving panel 10 are described. The plasma display apparatus displays an image by a subfield method, in which the plasma display apparatus divides one field into a plurality of subfields, and controls light emission and no light emission of each discharge cell in each subfield.

In the present exemplary embodiment, each subfield has an address period, a sustain period, and an erasing period. In the present exemplary embodiment, forced initializing operation of forcibly causing initializing discharge is not performed regardless of previous existence of discharge.

In the address period, address operation of selectively causing address discharge in the discharge cell to emit light and producing wall charge is performed. In the sustain period, sustain operation is performed that alternately applies as many sustain pulses as a predetermined number corresponding to a predetermined luminance weight to the display electrode pairs in each subfield, and causes sustain discharge to emit light in the discharge cell having undergone the address discharge. The sustain period may be omitted in order to suppress the emission luminance. In the erasing period, erasing operation is performed that selectively causes the erasing discharge only in the discharge cell having undergone address discharge in the immediately preceding address period, erases the history of the wall charge produced by address discharge or the subsequent sustain discharge, and produces the wall charge required for the subsequent address discharge on each electrode.

In this subfield structure, for example, one field is divided into 10 subfields (SF1, SF2, . . . , SF10), and respective subfields have luminance weights of (1, 2, 3, 6, 11, 18, 30, 44, 60, 80). The present invention is not limited to the above-mentioned subfield structure such as the number of subfields or the luminance weight.

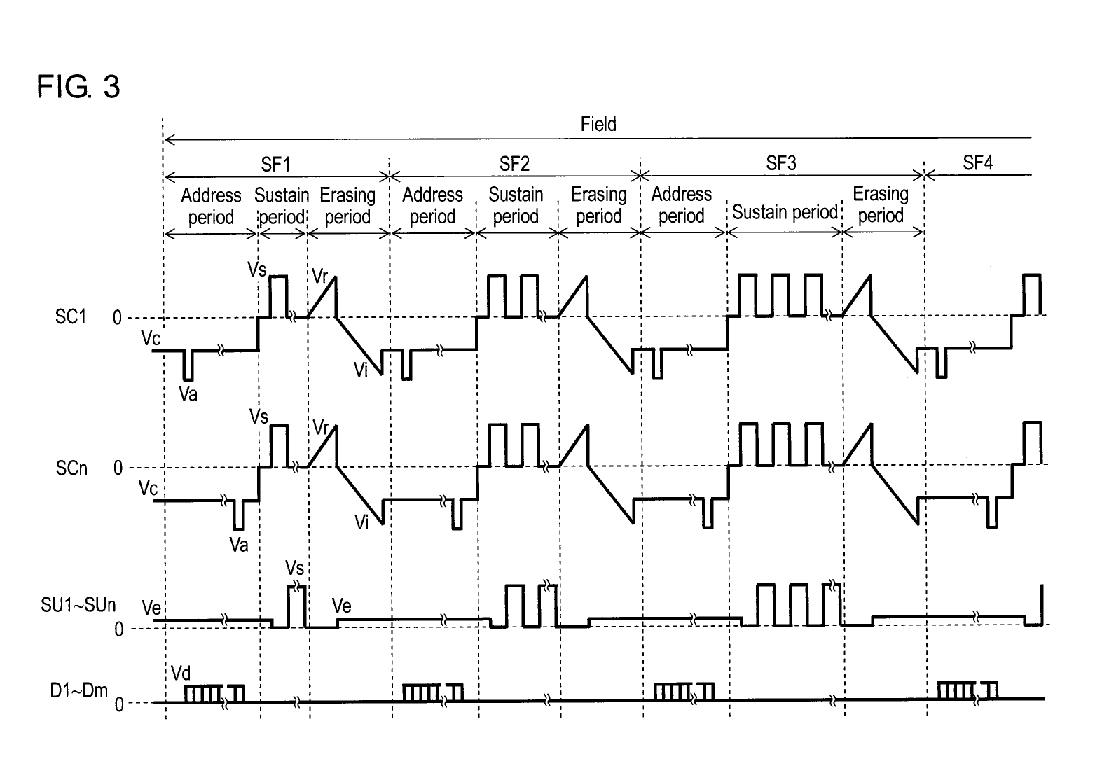

FIG. 3 is a waveform chart of driving voltage to be applied to each electrode of the plasma display apparatus in accordance with the first exemplary embodiment of the present invention.

In the address period of SF1, voltage 0 (V) is applied to data electrode D1 through data electrode Dm, voltage Ve is applied to sustain electrode SU1 through sustain electrode SUn, and voltage Vc is applied to scan electrode SC1 through scan electrode SCn. Next, a scan pulse of voltage Va is applied to scan electrode SC1 of the first row, and an address pulse of voltage Vd is applied to data electrode Dk corresponding to the discharge cell to emit light.

At this time, the voltage difference in the intersecting part of data electrode Dk and scan electrode SC1 is derived by adding positive wall voltage on data electrode Dk to difference (Vd−Va) of the external applied voltage, and exceeds discharge start voltage VFds. Discharge thus occurs between data electrode Dk and scan electrode SC1. Therefore, the discharge occurring between data electrode Dk and scan electrode SC1 develops and causes address discharge between scan electrode SC1 and sustain electrode SU1. Thus, positive wall voltage is accumulated on scan electrode SC1, negative wall voltage is accumulated on sustain electrode SU1, and negative wall voltage is also accumulated on data electrode Dk. Here, the wall voltage on the electrodes shows voltage generated by the wall charge accumulated on the dielectric layer for covering the electrodes, the protective layer, and the phosphor layer.

Thus, address operation of causing address discharge in the discharge cell to emit light in the first row and accumulating wall voltage on each electrode is performed. The voltage in the part where scan electrode SC1 intersects with data electrode Dh to which no address pulse is applied does not exceed discharge start voltage VFds, so that address discharge does not occur.

Next, a scan pulse is applied to scan electrode SC2 of the second row, and an address pulse is applied to data electrode Dk corresponding to the discharge cell to emit light. At this time, address discharge occurs between data electrode Dk and scan electrode SC2 and between sustain electrode SU2 and scan electrode SC2. Thus, positive wall voltage is accumulated on scan electrode SC2, negative wall voltage is accumulated on sustain electrode SU2, and negative wall voltage is also accumulated on data electrode Dk. Thus, address operation of causing address discharge in the discharge cell to emit light in the second row and accumulating wall voltage on each electrode is performed. The voltage in the part where scan electrode SC2 intersects with data electrode Dh to which no address pulse has been applied does not exceed the discharge start voltage VFds, so that address discharge does not occur.

Similar address operation is performed until it reaches scan electrode SCn of the n-th row, thereby producing the wall charge required for subsequent sustain discharge.

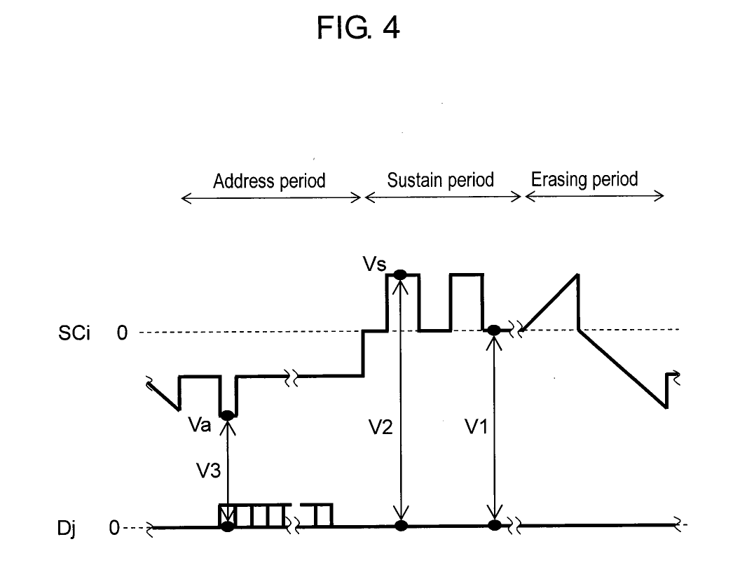

For later description, first voltage V1, second voltage V2, and third voltage V3 are defined as in FIG. 4. First voltage V1 is assumed to be the voltage derived by subtracting the voltage applied to data electrode Dj from the low-side voltage of the sustain pulse applied to scan electrode SCi in the sustain period discussed later. Second voltage V2 is assumed to be the voltage derived by subtracting the voltage applied to data electrode Dj from the high-side voltage of the sustain pulse applied to scan electrode SCi in the sustain period. Third voltage V3 is assumed to be the voltage derived by subtracting the low-side voltage of the address pulse applied to data electrode Dj from the low-side voltage of the scan pulse applied to scan electrode SCi in the address period.

The discharge start voltage where data electrode Dj is used as the positive electrode and scan electrode SCi is used as the negative electrode is assumed to be discharge start voltage VFds. The discharge start voltage where data electrode Dj is used as the negative electrode and scan electrode SCi is used as the positive electrode is assumed to be discharge start voltage VFsd. In the discharge where data electrode Dj is used as the positive electrode and scan electrode SCi is used as the negative electrode, data electrode Dj exists on the high potential side and scan electrode SCi exists on the low potential side in the electric field in the discharge cell when the discharge occurs. In the discharge where data electrode Dj is used as the negative electrode and scan electrode SCi is used as the positive electrode, data electrode Dj exists on the low potential side and scan electrode SCi exists on the high potential side in the electric field in the discharge cell when the discharge occurs. Protective layer 26 made of magnesium oxide of high electron discharge performance is formed on the scan electrode SCi side, so that discharge start voltage VFds is lower than discharge start voltage VFsd.

At this time, voltage Va of the scan pulse applied to scan electrode SCi is set so as to satisfy the following two conditions (Condition 1) and (Condition 2).

(Condition 1) In all discharge cells, the voltage derived by subtracting third voltage V3 from first voltage V1 is not lower than discharge start voltage VFds where data electrode Dj is used as the positive electrode and scan electrode SCi is used as the negative electrode, namely (V1−V3)≧VFds is satisfied.

(Condition 2) In all discharge cells, the voltage derived by subtracting third voltage V3 from second voltage V2 does not exceed the sum of discharge start voltage VFds where data electrode Dj is used as the positive electrode and scan electrode SCi is used as the negative electrode and discharge start voltage VFsd where data electrode Dj is used as the negative electrode and scan electrode SCi is used as the positive electrode, namely (V2−V3)≦(VFds+VFsd) is satisfied.

In the subsequent sustain period of SF1 after the address period, voltage 0 (V) is applied to sustain electrode SU1 through sustain electrode SUn, and a sustain pulse of voltage Vs is applied to scan electrode SC1 through scan electrode SCn. In the discharge cell having undergone the address discharge, the voltage difference between scan electrode SCi and sustain electrode SUi is derived by adding the difference between the wall voltage on scan electrode SCi and that on sustain electrode SUi to voltage Vs, and exceeds discharge start voltage VFss between scan electrode SCi and sustain electrode SUi. Thus, sustain discharge occurs between scan electrode SCi and sustain electrode SUi, and ultraviolet rays generated at this time cause phosphor layer 35 to emit light. Negative wall voltage is accumulated on scan electrode SCi, and positive wall voltage is accumulated on sustain electrode SUi. Positive wall voltage is also accumulated on data electrode Dk. In the discharge cell having undergone no address discharge, sustain discharge does not occur and the wall voltage at the end of the initializing period is kept.

Subsequently, voltage 0 (V) is applied to scan electrode SC1 through scan electrode SCn, and a sustain pulse of voltage Vs is applied to sustain electrode SU1 through sustain electrode SUn. In the discharge cell having undergone the sustain discharge, sustain discharge occurs again and phosphor layer 35 emits light. Therefore, negative wall voltage is accumulated on sustain electrode SUi, and positive wall voltage is accumulated on scan electrode SCi. Hereinafter, similarly, as many sustain pulses as the number corresponding to the luminance weight are alternately applied to scan electrode SC1 through scan electrode SCn and sustain electrode SU1 through sustain electrode SUn to continuously cause sustain discharge in the discharge cell having undergone the address discharge.

In the subsequent erasing period of. SF1, voltage 0 (V) is applied to sustain electrode SU1 through sustain electrode SUn, and up-ramp waveform voltage, which gently increases to voltage Vr, is applied to scan electrode SC1 through scan electrode SCn. In the present embodiment, voltage Vr is set to be same as voltage Vs. In the discharge cell having undergone the sustain discharge (the discharge cell having undergone the address discharge in the case where the sustain period is omitted), feeble erasing discharge occurs between scan electrode SCi and sustain electrode SUi. The wall voltage on scan electrode SCi and the wall voltage on sustain electrode SUi are reduced.

Then, voltage Ve is applied to sustain electrode SU1 through sustain electrode SUn, and down-ramp waveform voltage, which gently decreases from voltage 0 (V) to voltage Vi, is applied to scan electrode SC1 through scan electrode SCn. Voltage Vi is set to be equal to or slightly higher than voltage Va of the scan pulse.

Then, feeble discharge occurs again in the discharge cell having undergone the feeble erasing discharge, excessive part of the wall voltage on scan electrode SCi, the wall voltage on sustain electrode SUi, and the wall voltage on data electrode Dk is discharged, and these wall voltages are adjusted to wall voltages appropriate for the address operation. Thus, the erasing operation is completed.

Each operation of subsequent SF2 through SF10 is similar to the operation of the SF1 except for the number of sustain pulses.

In the present embodiment, voltage Vi is voltage −260 (V), voltage Vc is voltage −145 (V), voltage Va is voltage −280 (V), voltage Vs is voltage 200 (V), voltage Vr is voltage 200 (V), voltage Ve is voltage 20 (V), and voltage Vd is voltage 60 (V). However, these voltage values are not limited to the above-mentioned values, and preferably are set optimally based on the discharge characteristic of the panel and the specification of the plasma display apparatus.

Discharge start voltage VFds and discharge start voltage VFsd of panel 10 used in the present embodiment are measured by the method discussed later, and have the following values. The discharge start voltages depend on the phosphor. Discharge start voltage VFds and discharge start voltage VFsd between “data electrode and scan electrode” for the discharge cell coated with a red phosphor are voltage 200±10 (V) and voltage 320±10 (V), respectively. Discharge start voltage VFds and discharge start voltage VFsd between “data electrode and scan electrode” for the discharge cell coated with a green phosphor are voltage 220±10 (V) and voltage 350±10 (V), respectively. Discharge start voltage VFds and discharge start voltage VFsd between “data electrode and scan electrode” for the discharge cell coated with a blue phosphor are voltage 200±10 (V) and voltage 330±10 (V), respectively. Discharge start voltage VFss between “scan electrode and sustain electrode” is voltage 250±10 (V) for the discharge cells coated with red and blue phosphors, and voltage 280±10 (V) for the discharge cell coated with a green phosphor.

In the present embodiment, the voltage on the low voltage side of the sustain pulse is voltage 0 (V) and the voltage applied to the data electrode in the sustain period is voltage 0 (V), so that first voltage V1 is voltage 0 (V). The voltage on the low voltage side of the scan pulse is voltage Va and the voltage on the low voltage side of the address pulse is voltage 0 (V), so that third voltage V3 is voltage Va. The maximum value of discharge start voltage VFds is voltage 230 (V) in consideration of variation. Therefore, (first voltage V1−third voltage V3)=−Va>(maximum value of voltage VFds), namely 280 (V)>230 (V). Therefore, (Condition 1) is satisfied in all discharge cells.

The voltage on the high voltage side of the sustain pulse is voltage Vs and the voltage applied to the data electrode in the sustain period is voltage 0 (V), so that second voltage V2 is voltage Vs. The minimum value of the sum of discharge start voltage VFds and discharge start voltage VFsd is voltage 500 (V). Therefore, (second voltage V2−third voltage V3)=Vs−Va<minimum value of (VFds+VFsd), namely 480 (V)<500 (V). Therefore, (Condition 2) is also satisfied in all discharge cells.

As is clear from the above-mentioned voltages, voltage that is low-side voltage Va of the scan pulse or higher and is high-side voltage Vs of the sustain pulse or lower is applied to the scan electrode, and voltage lower than low-side voltage Va of the scan pulse or voltage higher than high-side voltage Vs of the sustain pulse is not applied. Therefore, light is not emitted in the discharge cell having undergone no address discharge.

As is clear from the above-mentioned voltages, when voltage Va is set to be low so as to satisfy (Condition 1), absolute value |Va| of low-side voltage Va of the scan pulse is larger than absolute value |Vs| of high-side voltage Vs of the sustain pulse.

Thus, in the present embodiment, when a driving voltage waveform to be applied to each electrode, especially voltage Va of the scan pulse, is set so as to satisfy (Condition 1) and (Condition 2), the address operation can be stably performed without using forced initializing operation. The reason for this is considered as shown below.

First, (Condition 1) is described. In order to cause address discharge, discharge is required to be started between data electrode Dj and scan electrode SCi. In order to start the discharge by applying relatively low voltage Vda to data electrode Dj, sufficient positive wall voltage must be accumulated on data electrode Dj so as to apply voltage substantially equal to discharge start voltage VFds between data electrode Dj and scan electrode SCi when a scan pulse is applied to scan electrode SCi. Since no forced initializing operation is performed and discharge is not caused in the discharge cell for displaying black in the present embodiment, the wall voltage cannot be controlled actively and the wall voltage of the discharge cell for displaying black becomes unstable. When a few charged particles exist in the discharge space even in this discharge cell, however, the charged particles move to each electrode so as to reduce the electric field in the discharge space, and adhere to the wall of the discharge cell to accumulate wall voltage.

First, the accumulated wall voltage is described. In the sustain period, many charged particles occur in the discharge cell for causing sustain discharge. Therefore, it is considered that the charged particles diffuse and a slight part of them is supplied also to the space in the discharge cell for displaying black without causing sustain discharge. Therefore, in the discharge cell for displaying black, wall voltage is gradually accumulated so as to reduce the electric potential difference between electrodes by voltage applied to each of scan electrode SCi, sustain electrode SUi, and data electrode Dj. When the voltage which the wall voltage approaches (finally becomes stable) is defined as left wall voltage, the left wall voltage when a sustain pulse is continuously and alternately applied to scan electrode SCi and sustain electrode SUi is the voltage between the high-side voltage and the low-side voltage of the sustain pulse. A driving voltage waveform other than the sustain pulse is actually applied, so that it may be considered that the left wall voltage of each discharge cell is substantially close to the low-side voltage of the sustain pulse.

The left wall voltage is largely affected by the charge characteristic of the phosphor applied to the inside of the discharge cell. In the present embodiment, the charge characteristic of a red phosphor is +20 (μC/g), the charge characteristic of a green phosphor is −30 (μC/g), and the charge characteristic of a blue phosphor is +10 (μC/g). Only the green phosphor has a characteristic of charging to negative electric potential, so that the left wall voltage for the green phosphor is lower than those for the red and blue phosphors.

Next, the voltage in the discharge cell in the address period is described. On data electrode Dj of the discharge cell for displaying black, wall voltage is gradually accumulated to substantially reach the low-side voltage of the sustain pulse or the left wall voltage higher than it. Voltage Va of the scan pulse of the present embodiment is the voltage satisfying (Condition 1). Therefore, on data electrode Dj, positive wall voltage enough to cause the address discharge is accumulated, and address discharge can be caused even when forced initializing operation is not performed at all.

The wall voltage of the discharge cell for displaying black gradually approaches the left wall voltage. In the erasing period, dark current flows when the voltage derived by adding the wall voltage to the voltage between “data electrode and scan electrode” approaches the discharge start voltage, and the wall voltage on data electrode Dj is reduced. The dark current flowing at this time plays a role as priming assisting address discharge, so that stable address discharge can be caused without causing long discharge delay even in the discharge cell having displayed black.

Thus, the driving voltage to be applied to each electrode is set to be low so as to satisfy (Condition 1), especially voltage Va of the scan pulse is set to be low so as to satisfy (Condition 1), thereby accumulating the wall voltage required for address without forced initializing operation and also causing priming for stabilizing the address discharge.

Next, (Condition 2) is described. When the voltage Va of the scan pulse is excessively decreased, discharge occurs to make image display impossible regardless of the existence of the address operation at the time when voltage Vs of the sustain pulse is applied to scan electrode SCn in the sustain period. In order to suppress this improper discharge, the voltage between “data electrode and scan electrode” must be set to be discharge start voltage VFsd or lower at the time when voltage Vs of the sustain pulse is applied. This condition is (Condition 2).

Thus, the driving voltage waveform is set so as to satisfy (Condition 1) and (Condition 2) in all discharge cells in the present embodiment. Therefore, the forced initializing operation is omitted while the address operation is stably caused, and image display where light emission related to no gradation display is eliminated is allowed.

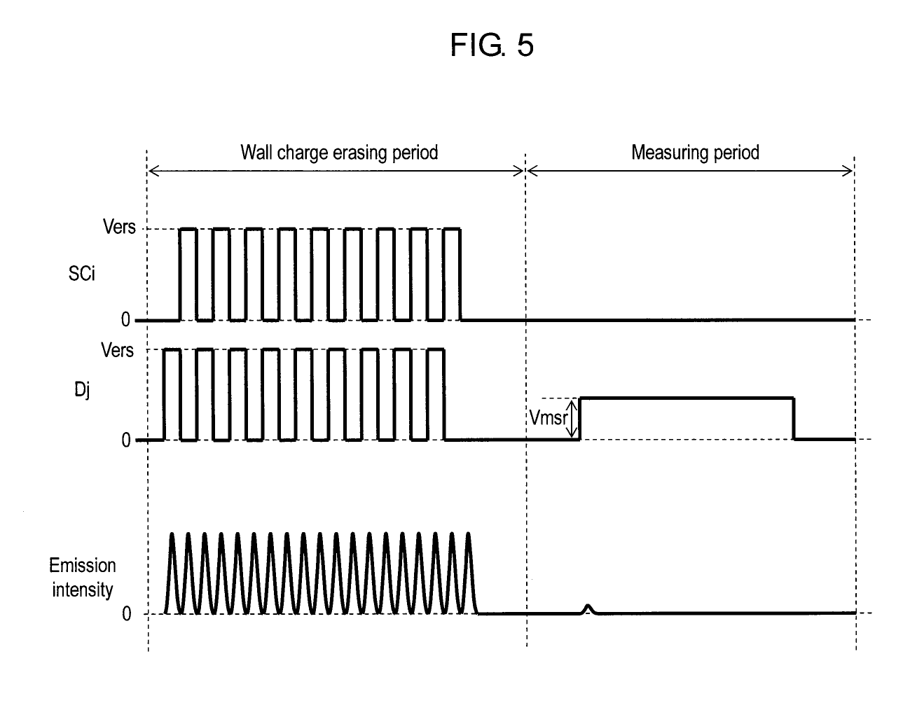

Next, discharge start voltage VFsd, discharge start voltage VFds, and wall voltage can be measured by a method described in IEEE TRANSACTIONS ON ELECTRON DEVICES, VOL. ED-24, NO.7, JULY, 1977 “Measurement of a Plasma in the AC Plasma Display Panel Using RF Capacitance and Microwave Techniques”. Alternatively, they may be simply measured as shown below. One example of the method of simply measuring the discharge start voltages is described using FIG. 5.

First, operation of erasing wall charge is performed. Specifically, as shown in the wall charge erasing period of FIG. 5, pulse-like voltage Vers sufficiently higher than an estimated discharge start voltage is alternately applied to electrodes intended to be measured, for example the data electrode and scan electrode. Then, the start of discharge is observed. Specifically, as shown in the measuring period of FIG. 5, pulse-like voltage Vmsr lower than the estimated discharge start voltage is applied to one of the electrodes, for example the data electrode, and light emission following the discharge at this time is detected using a light detection sensor such as a photomultiplier tube. When discharge is not observed, the operation of erasing wall charge is performed in the wall charge erasing period, then pulse-like voltage Vmsr whose absolute value is slightly increased is applied in the measuring period, and light emission is observed.

This operation is repeated, and voltage Vmsr that has the minimum absolute value and at which light emission is observed in the measuring period is discharge start voltage. When voltage Vmsr applied in the measuring period is assumed to be positive, discharge start voltage VFds where the data electrode is used as the positive electrode and the scan electrode is used as the negative electrode can be measured. When voltage Vmsr applied in the measuring period is assumed to be negative, discharge start voltage VFsd where the data electrode is used as the negative electrode and the scan electrode is used as the positive electrode can be measured.

When the discharge start voltage is measured, the voltage at which discharge starts in the discharge cell having accumulated wall voltage is measured, wall voltage can be obtained by calculating the difference between the voltage value and the previously measured discharge start voltage.

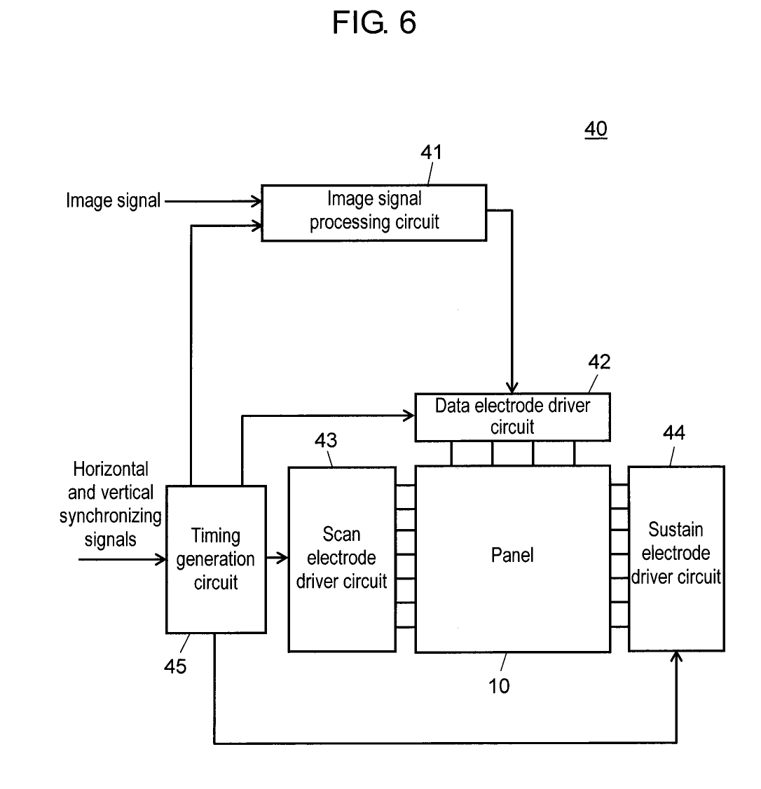

Next, a driver circuit for driving panel 10 is described. FIG. 6 is a circuit block diagram of plasma display apparatus 40 in accordance with the first exemplary embodiment of the present invention. Plasma display apparatus 40 has panel 10 and a driver circuit thereof. The driver circuit includes the following elements:
image signal processing circuit 41;
data electrode driver circuit 42;
scan electrode driver circuit 43;
sustain electrode driver circuit 44;
timing generation circuit 45; and
a power supply circuit (not shown) for supplying required power to each circuit block.

Image signal processing circuit 41 converts an input image signal into image data that indicates light emission or no light emission in each subfield. Data electrode driver circuit 42 converts the image data in each subfield into an address pulse corresponding to each of data electrode D1 through data electrode Dm, and applies it to each of data electrode D1 through data electrode Dm. Timing generation circuit 45 generates various timing signals for controlling operations of respective circuit blocks based on a vertical synchronizing signal and a horizontal synchronizing signal, and supplies the timing signals to respective circuit blocks. Scan electrode driver circuit 43 generates the above-mentioned driving voltage waveform based on the timing signals, and applies it to each of scan electrode SC1 through scan electrode SCn. Sustain electrode driver circuit 44 generates the above-mentioned driving voltage waveform based on the timing signals, and applies it to sustain electrode SU1 through sustain electrode SUn based on the timing signal.

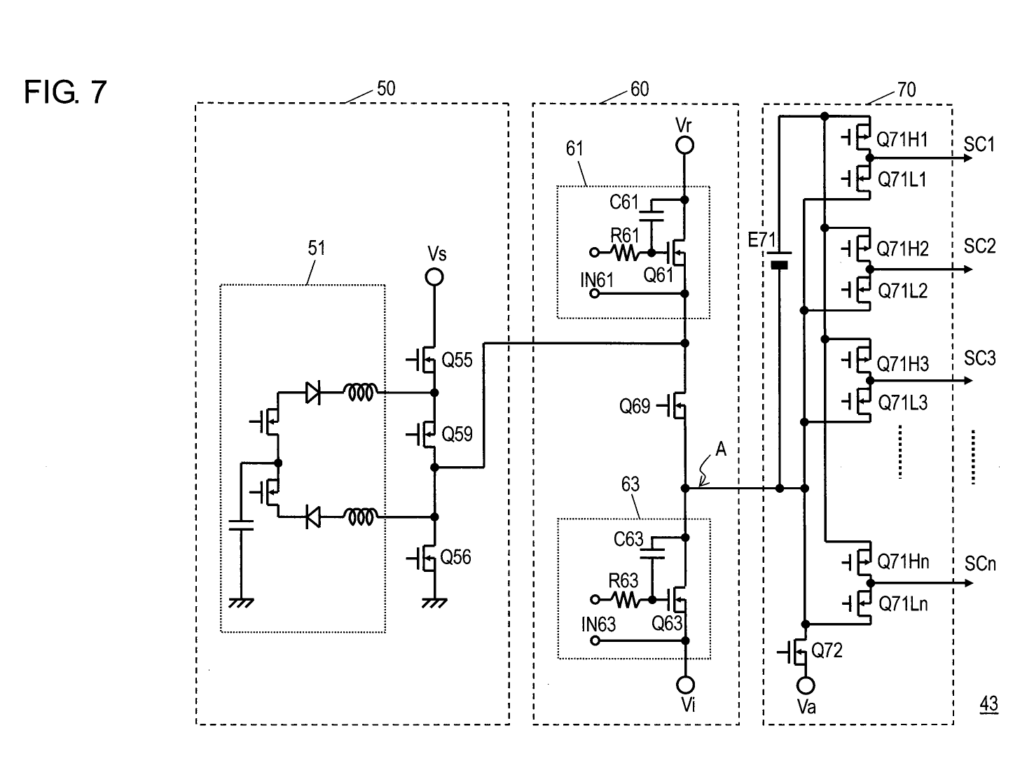

FIG. 7 is a circuit diagram of scan electrode driver circuit 43 of plasma display apparatus 40 in accordance with the first exemplary embodiment of the present invention. Scan electrode driver circuit 43 has sustain pulse generation circuit 50, ramp waveform voltage generation circuit 60, and scan pulse generation circuit 70.

Sustain pulse generation circuit 50 has power recovery circuit 51, switching element Q55, switching element Q56, and switching element Q59, and generates sustain pulses to be applied to scan electrode SC1 through scan electrode SCn. Power recovery circuit 51 recovers electric power in driving scan electrode SC1 through scan electrode SCn, and reuses it. Switching element Q55 clamps scan electrode SC1 through scan electrode SCn on voltage Vs, and switching element Q56 clamps scan electrode SC1 through scan electrode SCn on voltage 0 (V). Switching element Q59 is a separation switch, and prevents current from flowing back via a parasitic diode or the like of the switching element that is included in scan electrode driver circuit 43.

Scan pulse generation circuit 70 has switching element Q71H1 through switching element Q71Hn, switching element Q71L1 through switching element Q71Ln, and switching element Q72. A scan pulse is generated based on a power supply of voltage Va and power supply E71 of voltage (Vc−Va) superimposed on the reference potential (potential at node A shown in FIG. 7) of scan pulse generation circuit 70. A scan pulse is sequentially applied to scan electrode SC1 through scan electrode SCn with the timings shown in FIG. 3. Scan pulse generation circuit 70 outputs the output voltage of sustain pulse generation circuit 50 as it is during sustain operation. In other words, scan pulse generation circuit 70 outputs the voltage at node A to scan electrode SC1 through scan electrode SCn.

Ramp waveform voltage generation circuit 60 has Miller integrating circuit 61 and Miller integrating circuit 63, and generates the ramp waveform voltage shown in FIG. 3. Miller integrating circuit 61 has transistor Q61, capacitor C61, and resistor R61, and applies a fixed voltage to input terminal IN61 to generate up-ramp waveform voltage that gently increases to voltage Vr. Miller integrating circuit 63 has transistor Q63, capacitor C63, and resistor R63, and applies a fixed voltage to input terminal IN63 to generate down-ramp waveform voltage that gently decreases to voltage Vi. Switching element Q69 is also a separation switch, and prevents current from flowing back via a parasitic diode or the like of the switching element that is included in scan electrode driver circuit 43.

These switching elements and transistors can be formed of generally known elements such as a metal oxide semiconductor field effect transistor (MOSFET) or an insulated gate bipolar transistor (IGBT). These switching elements and transistors are controlled with timing signals that correspond to the switching elements and transistors and are generated in timing generation circuit 45.

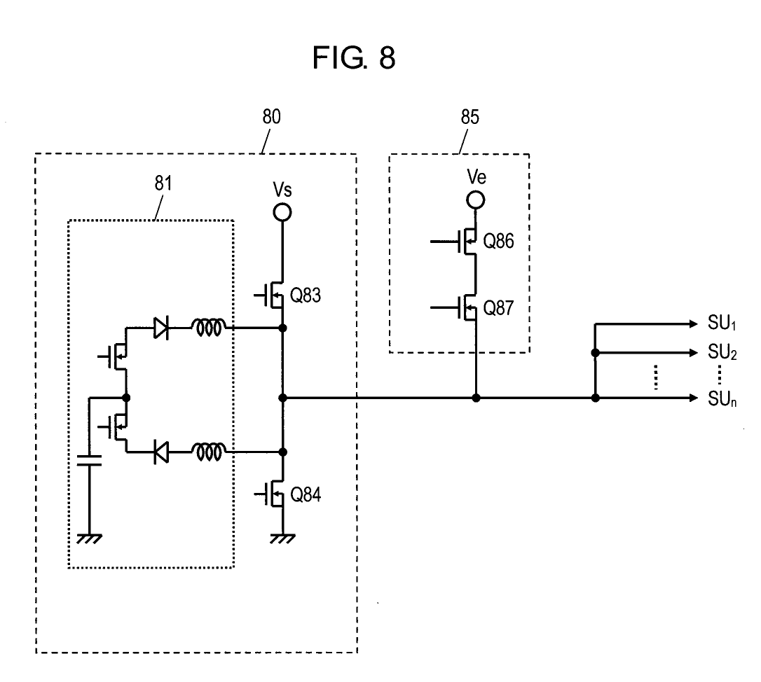

FIG. 8 is a circuit diagram of sustain electrode driver circuit 44 of plasma display apparatus 40 in accordance with the first exemplary embodiment of the present invention. Sustain electrode driver circuit 44 has sustain pulse generation circuit 80 and fixed voltage generation circuit 85.

Sustain pulse generation circuit 80 has power recovery circuit 81, switching element Q83, and switching element Q84, and generates a sustain pulse to be applied to sustain electrode SU1 through sustain electrode SUn. Power recovery circuit 81 recovers electric power in driving sustain electrode SU1 through sustain electrode SUn, and reuses it. Switching element Q83 clamps sustain electrode SU1 through sustain electrode SUn on voltage Vs, and switching element Q84 clamps sustain electrode SU1 through sustain electrode SUn on voltage 0 (V).

Fixed voltage generation circuit 85 has switching element Q86 and switching element Q87, and applies voltage Ve to sustain electrode SU1 through sustain electrode SUn.

These switching elements can be also formed of generally known elements such as a MOSFET or an IGBT. These switching elements are controlled with timing signals that correspond to the switching elements and are generated in timing generation circuit 45.

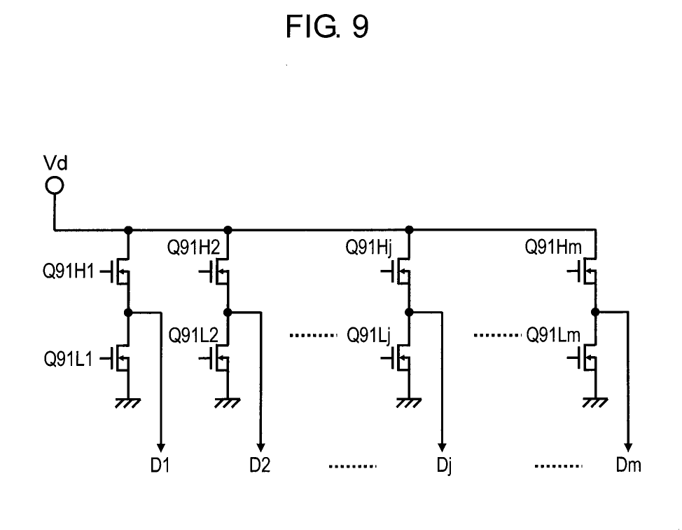

FIG. 9 is a circuit diagram of data electrode driver circuit 42 of plasma display apparatus 40 in accordance with the first exemplary embodiment of the present invention. Data electrode driver circuit 42 has switching element Q91H1 through switching element Q91Hm, and switching element Q91L1 through switching element Q91Lm. Voltage 0 (V) is applied to data electrode Dj by setting switching element Q91Lj at ON, and voltage Vd is applied to data electrode Dj by setting switching element Q91Hj at ON.

Using such a driver circuit, the driving voltage waveform of the panel shown in FIG. 3 can be generated. However, the driver circuits of FIG. 6 through FIG. 9 are one example, the present invention is not limited to the configurations of these driver circuits.

In a driving method for a panel and a plasma display apparatus of the present embodiment, a stable address operation can be performed and the contrast is improved without using a forced initializing operation by applying a scan pulse satisfying (Condition 1) and (Condition 2) to the scan electrode.

### Second Exemplary Embodiment

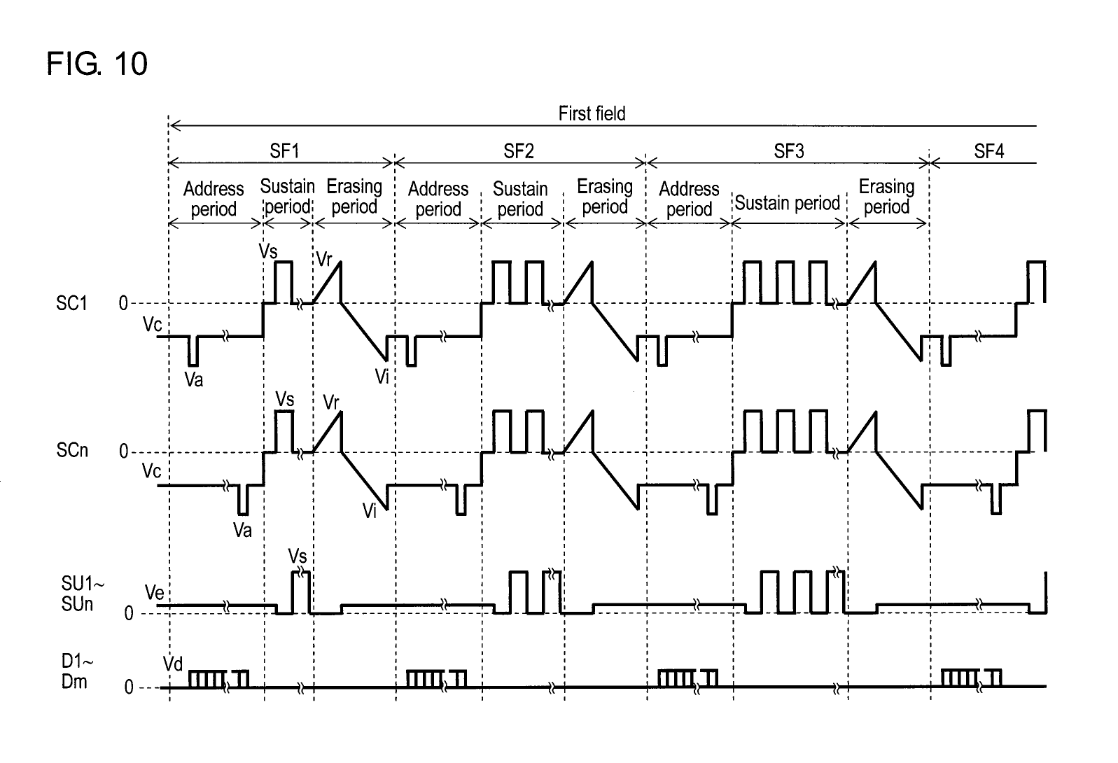

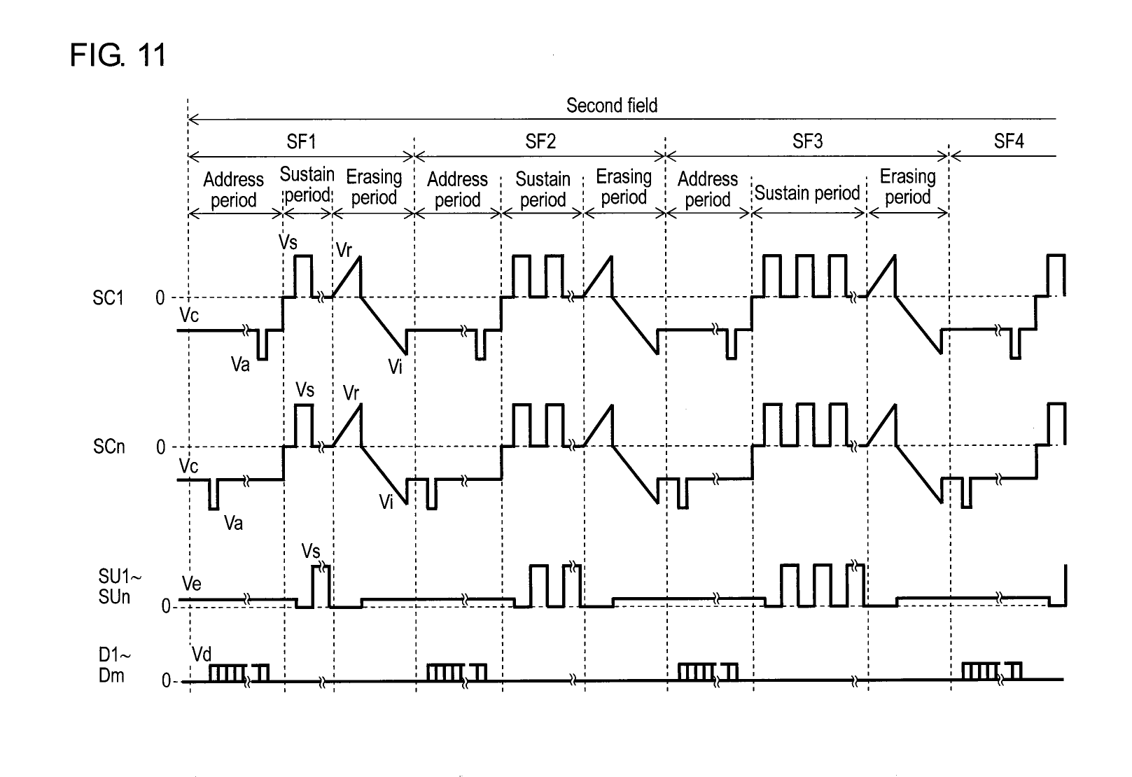

FIG. 10 and FIG. 11 are waveform charts of driving voltage to be applied to each electrode of a plasma display apparatus in accordance with a second exemplary embodiment of the present invention. FIG. 10 shows the driving voltage waveform in the first field, and FIG. 11 shows the driving voltage waveform in the second field.

In the address period of SF1 of the first field, voltage 0 (V) is applied to data electrode D1 through data electrode Dm, voltage Ve is applied to sustain electrode SU1 through sustain electrode SUn, and voltage Vc is applied to scan electrode SC1 through scan electrode SCn. Next, a scan pulse of voltage Va is applied to scan electrode SC1 of the first row, and an address pulse of voltage Vd is applied to data electrode Dk corresponding to the discharge cell to emit light.

At this time, the voltage difference in the intersecting part of data electrode Dk and scan electrode SC1 is derived by adding positive wall voltage on data electrode Dk to the difference (Vd−Va) of the external applied voltage, and exceeds discharge start voltage VFds. Discharge thus occurs between data electrode Dk and scan electrode SC1. Therefore, the discharge occurring between data electrode Dk and scan electrode SC1 develops and causes address discharge between scan electrode SC1 and sustain electrode SU1. Thus, positive wall voltage is accumulated on scan electrode SC1, negative wall voltage is accumulated on sustain electrode SU1, and negative wall voltage is also accumulated on data electrode Dk. Here, the wall voltage on the electrodes shows voltage generated by the wall charge accumulated on the dielectric layer for covering the electrodes, the protective layer, and the phosphor layer.

Thus, address operation of causing address discharge in the discharge cell to emit light in the first row and accumulating wall voltage on each electrode is performed. The voltage in the part where scan electrode SC1 intersects with data electrode Dh to which no address pulse is applied does not exceed discharge start voltage VFds, so that address discharge does not occur.

Next, a scan pulse is applied to scan electrode SC2 of the second row, and an address pulse is applied to data electrode Dk corresponding to the discharge cell to emit light. At this time, address discharge occurs between data electrode Dk and scan electrode SC2 and between sustain electrode SU2 and scan electrode SC2. Thus, positive wall voltage is accumulated on scan electrode SC2, negative wall voltage is accumulated on sustain electrode SU2, and negative wall voltage is also accumulated on data electrode Dk. Thus, address operation of causing address discharge in the discharge cell to emit light in the second row and accumulating wall voltage on each electrode is performed. The voltage in the part where scan electrode SC2 intersects with data electrode Dh to which no address pulse is applied does not exceed the discharge start voltage, so that address discharge does not occur.

Hereinafter, a scan pulse is sequentially applied to scan electrode SC2 of the second row, scan electrode SC3 of the third row, . . . , scan electrode SCn−1 of the (n−1)-th row, and scan electrode SCn of the n-th row. The address operation is performed in the discharge cell of the first row, the discharge cell of the second row, the discharge cell of the third row, . . . , the discharge cell of the (n−1)-th row, and the discharge cell of the n-th row in that order, thereby producing the wall charge required for subsequent sustain discharge.

Similarly to the first exemplary embodiment, first voltage V1, second voltage V2, and third voltage V3 are defined as in FIG. 4. First voltage V1 is assumed to be the voltage derived by subtracting the voltage applied to data electrode Dj from the low-side voltage of the sustain pulse applied to scan electrode SCi in the sustain period discussed later. Second voltage V2 is assumed to be the voltage derived by subtracting the voltage applied to data electrode Dj from the high-side voltage of the sustain pulse applied to scan electrode SCi in the sustain period. Third voltage V3 is assumed to be the voltage derived by subtracting the low-side voltage of the address pulse applied to data electrode Dj from the low side voltage of the scan pulse applied to scan electrode SCi in the address period.

The discharge start voltage where data electrode Dj is used as the positive electrode and scan electrode SCi is used as the negative electrode is assumed to be discharge start voltage VFds. The discharge start voltage where data electrode Dj is used as the negative electrode and scan electrode SCi is used as the positive electrode is assumed to be discharge start voltage VFsd. In the discharge where data electrode Dj is used as the positive electrode and scan electrode SCi is used as the negative electrode, data electrode Dj exists on the high potential side and scan electrode SCi exists on the low potential side in the electric field in the discharge cell when the discharge occurs. In the discharge where data electrode Dj is used as the negative electrode and scan electrode SCi is used as the positive electrode, data electrode Dj exists on the low potential side and scan electrode SCi exists on the high potential side in the electric field in the discharge cell when the discharge occurs. Protective layer 26 made of magnesium oxide of high electron discharge performance is formed on the scan electrode SCi side, so that discharge start voltage VFds is lower than discharge start voltage VFsd.

At this time, voltage Va of the scan pulse applied to scan electrode SCi is set so as to satisfy the following two conditions (Condition 1) and (Condition 2).

(Condition 1) In all discharge cells, the voltage derived by subtracting third voltage V3 from first voltage V1 is not lower than discharge start voltage VFds where data electrode Dj is used as the positive electrode and scan electrode SCi is used as the negative electrode, namely (V1−V3)≧VFds is satisfied.

(Condition 2) In all discharge cells, the voltage derived by subtracting third voltage V3 from second voltage V2 does not exceed the sum of discharge start voltage VFds where data electrode Dj is used as the positive electrode and scan electrode SCi is used as the negative electrode and discharge start voltage VFsd where data electrode Dj is used as the negative electrode and scan electrode SCi is used as the positive electrode, namely (V2−V3)≦(VFds+VFsd) is satisfied.

In the subsequent sustain period of SF1 after the address period, voltage 0 (V) is applied to sustain electrode SU1 through sustain electrode SUn, and a sustain pulse of voltage Vs is applied to scan electrode SC1 through scan electrode SCn. In the discharge cell having undergone the address discharge, the voltage difference between scan electrode SCi and sustain electrode SUi is derived by adding the difference between the wall voltage on scan electrode SCi and that on sustain electrode SUi to voltage Vs, and exceeds discharge start voltage VFss between scan electrode SCi and sustain electrode SUi. Thus, sustain discharge occurs between scan electrode SCi and sustain electrode SUi, and ultraviolet rays generated at this time cause phosphor layer 35 to emit light. Negative wall voltage is accumulated on scan electrode SCi, and positive wall voltage is accumulated on sustain electrode SUi. Positive wall voltage is also accumulated on data electrode Dk. In the discharge cell having undergone no address discharge, sustain discharge does not occur and the wall voltage at the end of the initializing period is kept.

Subsequently, voltage 0 (V) is applied to scan electrode SC1 through scan electrode SCn, and a sustain pulse of voltage Vs is applied to sustain electrode SU1 through sustain electrode SUn. In the discharge cell having undergone the sustain discharge, sustain discharge occurs again and phosphor layer 35 emits light. Therefore, negative wall voltage is accumulated on sustain electrode SUi, and positive wall voltage is accumulated on scan electrode SCi. Hereinafter, similarly, as many sustain pulses as the number corresponding to the luminance weight are alternately applied to scan electrode SC1 through scan electrode SCn and sustain electrode SU1 through sustain electrode SUn to continuously cause sustain discharge in the discharge cell having undergone the sustain discharge.

In the subsequent erasing period of SF1, voltage 0 (V) is applied to sustain electrode SU1 through sustain electrode SUn, and up-ramp waveform voltage, which gently increases to voltage Vr, is applied to scan electrode SC1 through scan electrode SCn. In the present embodiment, voltage Vr is set to be same as voltage Vs. In the discharge cell having undergone the sustain discharge (the discharge cell having undergone the address discharge in the case where the sustain period is omitted), feeble erasing discharge occurs between scan electrode SCi and sustain electrode SUi. The wall voltage on scan electrode SCi and the wall voltage on sustain electrode SUi are reduced.

Then, voltage Ve is applied to sustain electrode SU1 through sustain electrode SUn, and down-ramp waveform voltage, which gently decreases from voltage 0 (V) to voltage Vi, is applied to scan electrode SC1 through scan electrode SCn. Voltage Vi is set to be equal to or slightly higher than voltage Va of the scan pulse.

Then, feeble discharge occurs again in the discharge cell having undergone the feeble erasing discharge, excessive part of the wall voltage on scan electrode SCi, the wall voltage on sustain electrode SUi, and the wall voltage on data electrode Dk is discharged, and these wall voltages are adjusted to wall voltages appropriate for the address operation. Thus, the erasing operation is completed.

Each operation of subsequent SF2 through SF10 in the first field is similar to the operation of the SF1 except for the number of sustain pulses.

In the subsequent address period of SF1 of the second field, voltage 0 (V) is applied to data electrode D1 through data electrode Dm, voltage Ve is applied to sustain electrode SU1 through sustain electrode SUn, and voltage Vc is applied to scan electrode SC1 through scan electrode SCn. Next, a scan pulse of voltage Va is applied to scan electrode SCn of the n-th row, and an address pulse of voltage Vd is applied to data electrode Dk corresponding to the discharge cell to emit light. Similarly to the first field, voltage Va is set so as to satisfy (Condition 1) and (Condition 2).

Then, address operation is performed that causes address discharge between data electrode Dk and scan electrode SCn and between scan electrode SCn and sustain electrode SUn and accumulates wall voltage on each electrode of the discharge cell to emit light in the n-th row.

Next, address operation is performed that applies a scan pulse of voltage Va to scan electrode SCn−1 of the (n−1)-th row, applies an address pulse of voltage Vd to data electrode Dk corresponding to the discharge cell to emit light, and accumulates wall voltage on each electrode of the discharge cell of the (n−1)-th row. Hereinafter, the address operation is performed by sequentially applying a scan pulse to scan electrode SCn−2 of the (n−2)-th row, scan electrode SCn−3 of the (n−3)-th row, etc, and the similar address operation is performed until scan electrode SC1 of the first row.

Thus, in the address period of a subfield belonging to the second field, a scan pulse is sequentially applied to scan electrode SCn of the n-th row, scan electrode SCn−1 of the (n−1)-th row, scan electrode SCn−2 of the (n−2)-th row, . . . , scan electrode SC2 of the second row, and scan electrode SC1 of the first row. Then, the address operation is performed in the discharge cell of the n-th row, the discharge cell of the (n−1)-th row, the discharge cell of the (n−2)-th row, . . . , the discharge cell of the second row, and the discharge cell of the first row in that order. Thus, the address operation in the address period of the subfield belonging to the second field is performed in the order reverse to that of the address operation in the address period of the subfield belonging to the first field.

The operations in the subsequent sustain period and erasing period in SF1 of the second field are similar to those in SF1 of the first field. The operations in SF2 through SF10 of the second field are similar to those in SF2 through SF10 of the first field except that the order of the address operation in the address period is reverse.

Hereinafter, panel 10 is driven alternately using the first field and second field.

In the present embodiment, in the erasing period of all subfields, the erasing discharge is caused only in the discharge cell having undergone address discharge in the immediately preceding address period. In the present embodiment, discharge does not occur in the discharge cell having undergone no address discharge, and hence light emission does not occur in the discharge cell to display black.

In the present embodiment, similarly to the first embodiment, voltage Vi is voltage 260 (V), voltage Vc is voltage 145 (V), voltage Va is voltage 280 (V), voltage Vs is voltage 200 (V), voltage Vr is voltage 200 (V), voltage Ve is voltage 20 (V), and voltage Vd is voltage 60 (V). However, these voltage values are not limited to the above-mentioned values, and, preferably, are set optimally based on the discharge characteristic of the panel and the specification of the plasma display apparatus.

Discharge start voltage VFds and discharge start voltage VFsd of panel 10 used in the present embodiment are measured by the method similar to that of the first embodiment, and have the following values. The discharge start voltages depend on the phosphor. Discharge start voltage VFds and discharge start voltage VFsd between “data electrode and scan electrode” for the discharge cell coated with a red phosphor are voltage 200±10 (V) and voltage 320±10 (V), respectively. Discharge start voltage VFds and discharge start voltage VFsd between “data electrode and scan electrode” for the discharge cell coated with a green phosphor are voltage 220±10 (V) and voltage 350±10 (V), respectively. Discharge start voltage VFds and discharge start voltage VFsd between “data electrode and scan electrode” for the discharge cell coated with a blue phosphor are voltage 200±10 (V) and voltage 330±10 (V), respectively. Discharge start voltage VFss between “scan electrode and sustain electrode” is voltage 250±10 (V) for the discharge cells coated with red and blue phosphors, and voltage 280±10 (V) for the discharge cell coated with a green phosphor.

In the present embodiment, the voltage on the low voltage side of the sustain pulse is voltage 0 (V) and the voltage applied to the data electrode in the sustain period is voltage 0 (V), so that first voltage V1 is voltage 0 (V). The voltage on the low voltage side of the scan pulse is voltage Va and the voltage on the low voltage side of the address pulse is voltage 0 (V), so that third voltage V3 is voltage Va. The maximum value of discharge start voltage VFds is voltage 230 (V) in consideration of variation. Therefore, (first voltage V1−third voltage V3)=−Va>(maximum value of voltage VFds), namely 280 (V)>230 (V). Therefore, (Condition 1) is satisfied in all discharge cells.

The voltage on the high voltage side of the sustain pulse is voltage Vs and the voltage applied to the data electrode in the sustain period is voltage 0 (V), so that second voltage V2 is voltage Vs. The minimum value of the sum of discharge start voltage VFsd and discharge start voltage VFds is voltage 500 (V). Therefore, (second voltage V2−third voltage V3)=Vs−Va<minimum value of (VFds+VFsd), namely 480 (V)<500 (V). Therefore, (Condition 2) is also satisfied in all discharge cells.

As is clear from the above-mentioned voltages, voltage that is low-side voltage Va of the scan pulse or higher and is high-side voltage Vs of the sustain pulse or lower is applied to the scan electrode, and voltage lower than low-side voltage Va of the scan pulse or voltage higher than high-side voltage Vs of the sustain pulse is not applied. Therefore, light is not emitted in the discharge cell having undergone no address discharge.

As is clear from the above-mentioned voltages, when voltage Va is set to be low so as to satisfy (Condition 1), absolute value |Va| of low-side voltage Va of the scan pulse is larger than absolute value |Vs| of high-side voltage Vs of the sustain pulse.

Thus, in the present embodiment, a driving voltage waveform to be applied to each electrode, especially voltage Va of the scan pulse, is set so as to satisfy (Condition 1) and (Condition 2). In other words, in the erasing period, the erasing discharge is selectively caused only in the discharge cell that has undergone address discharge in the immediately preceding address period. The voltage derived by subtracting third voltage V3 from first voltage V1 is not lower than discharge start voltage VFds where data electrode Dj is used as the positive electrode and scan electrode SCi is used as the negative electrode. The voltage derived by subtracting third voltage V3 from second voltage V2 does not exceed the sum of discharge start voltage VFds where data electrode Dj is used as the positive electrode and scan electrode SCi is used as the negative electrode and discharge start voltage VFsd where data electrode Dj is used as the negative electrode and scan electrode SCi is used as the positive electrode. Here, first voltage V1 is assumed to be the voltage derived by subtracting the voltage applied to data electrode Dj from the low-side voltage of the sustain pulse applied to scan electrode SCi in the sustain period. Second voltage V2 is assumed to be the voltage derived by subtracting the voltage applied to data electrode Dj from the high-side voltage of the sustain pulse applied to scan electrode SCi in the sustain period. Third voltage V3 is assumed to be the voltage derived by subtracting the low-side voltage of the address pulse applied to data electrode Dj from the low-side voltage of the scan pulse applied to scan electrode SCi in the address period. This setting allows address operation similar to that of the first embodiment to be performed stably without using forced initializing operation.

The driving method of the present embodiment includes a first field and a second field. In the first field, a scan pulse is sequentially applied to a plurality of arranged scan electrodes in the order from one-side scan electrode SC1 to the-other-side scan electrode SCn in the address period. In the second field, a scan pulse is sequentially applied to the plurality of scan electrodes in the order from the-other-side scan electrode SCn to one-side scan SC1 electrode in the address period. Panel 10 is driven alternately using the first field and the second field. The reason for such driving is described as follows.

Operation when the image signal is switched from the display of black on the whole screen to the display of white on the whole screen is considered.

In the present embodiment, discharge is not caused in the discharge cell to display black as discussed above. Therefore, priming is small in each discharge cell, and discharge delay is long. When address operation is performed in this state, many discharge cells where discharge delay becomes long and address discharge fails can occur. When the address discharge is successfully performed in a certain discharge cell, however, the priming occurring in this discharge cell is supplied to an adjacent discharge cell. Therefore, in the discharge cell where address operation is performed immediately after the supply, the discharge delay becomes short and the probability of success in address discharge increases extremely.

When the panel is assumed to be driven using only the first field, in the address period, a scan pulse is always and sequentially applied to the scan electrodes in the order from scan electrode SC1 in an upper part of the display screen to scan electrode SCn in a lower part of the display screen. Therefore, in the discharge cells positioned under and obliquely under the discharge cell where address discharge is performed successfully, address discharge is continuously performed, and switching to the display of white is allowed. However, priming is not supplied from any part to the discharge cell on the discharge cell where address discharge is performed successfully, so that the probability of failing in address discharge is kept high. Therefore, long time is required until switching to the display of white in the upper part of the display screen, and the image display quality decreases.

When the panel is assumed to be driven using only the second field, in the address period, a scan pulse is always and sequentially applied to the scan electrodes from scan electrode SCn in the lower part of the display screen to scan electrode SC1 in the upper part of the display screen. Therefore, long time is required until switching to the display of white in the lower part of the display screen, and the image display quality decreases.

In the present embodiment, however, the panel is driven alternately using the first field and the second field, so that the discharge delay can be shortened over the whole screen and switching to the display of white can be rapidly performed.

The present embodiment has been described as follows. In the first field, a scan pulse is sequentially applied to the scan electrodes in the order from one-side scan electrode SC1 to the-other-side scan electrode SCn in the address period in all subfields. In the second field, a scan pulse is sequentially applied to the scan electrodes in the order from the-other-side scan electrode SCn to one-side scan electrode SC1. However, in the address period of SF1 of the lowest luminance weight, which is the subfield having high probability of performing address operation, panel 10 is driven alternately using the field in which address operation is performed from one side to the other side and the field in which address operation is performed from the other side to one side. Thus, similar advantage can be taken.

In the driving method for the panel and the plasma display apparatus of the present embodiment, by applying the scan pulse satisfying the above-mentioned conditions to scan electrodes, stable address operation of short discharge delay can be performed and the contrast is improved without using the forced initializing operation.

The specific numerical values shown in the first exemplary embodiment and the second exemplary embodiment are simply examples. Preferably, these numerical values are set optimally in response to the characteristic of the panel and the specification of the plasma display apparatus.

### INDUSTRIAL APPLICABILITY

The present invention can provide a driving method for a plasma display panel and a plasma display apparatus capable of omitting a forced initializing operation while address operation is performed stably, eliminating light emission that is not related to gradation display, and improving the contrast.

### REFERENCE MARKS IN THE DRAWINGS

10 panel
22 scan electrode
23 sustain electrode
24 display electrode pair
32 data electrode
35 phosphor layer
40 plasma display apparatus
41 image signal processing circuit
42 data electrode driver circuit
43 scan electrode driver circuit
44 sustain electrode driver circuit
45 timing generation circuit
50, 80 sustain pulse generation circuit
51, 81 power recovery circuit
60 ramp waveform voltage generation circuit
61, 63 Miller integrating circuit
70 scan pulse generation circuit
85 fixed voltage generation circuit

1. A driving method for a plasma display panel comprising:
forming one field using a plurality of subfields each of which has an address period, a sustain period, and an erasing period; and
driving a plasma display panel having a plurality of discharge cells each of which has a scan electrode, a sustain electrode, and a data electrode,
wherein, in the erasing period, erasing discharge is selectively generated only in a discharge cell that has undergone address discharge in an immediately preceding address period,
wherein, when
first voltage is assumed to be voltage derived by subtracting voltage applied to the data electrode from low-side voltage of a sustain pulse applied to the scan electrode in the sustain period,
second voltage is assumed to be voltage derived by subtracting voltage applied to the data electrode from high-side voltage of the sustain pulse applied to the scan electrode in the sustain period, and
third voltage is assumed to be voltage derived by subtracting low-side voltage of an address pulse applied to the data electrode from low-side voltage of a scan pulse applied to the scan electrode in the address period,
voltage derived by subtracting the third voltage from the first voltage is not lower than a discharge start voltage where the data electrode is used as a positive electrode and the scan electrode is used as a negative electrode, and
voltage derived by subtracting the third voltage from the second voltage does not exceed the sum of a discharge start voltage where the data electrode is used as a positive electrode and the scan electrode is used as a negative electrode, and a discharge start voltage where the data electrode is used as a negative electrode and the scan electrode is used as a positive electrode.

2. The driving method for the plasma display panel of claim 1, wherein
voltage that is not less than the low-side voltage of the scan pulse and not more than the high-side voltage of the sustain pulse is applied to the scan electrode.

3. The driving method for the plasma display panel of claim 1, wherein
an absolute value of the low-side voltage of the scan pulse is larger than an absolute value of the high-side voltage of the sustain pulse.

4. A plasma display apparatus comprising:
a plasma display panel having a plurality of discharge cells each of which has a scan electrode, a sustain electrode, and a data electrode; and
a driver circuit that forms one field using a plurality of subfields each of which has an address period, a sustain period, and an erasing period, generates a driving voltage waveform, and applies the driving voltage waveform to each electrode of the plasma display panel,
wherein the driver circuit, in the erasing period, drives the plasma display panel by selectively causing the erasing discharge only in a discharge cell that has undergone address discharge in an immediately preceding address period, and
wherein, when
first voltage is assumed to be voltage derived by subtracting voltage applied to the data electrode from low-side voltage of a sustain pulse applied to the scan electrode in the sustain period,
second voltage is assumed to be voltage derived by subtracting voltage applied to the data electrode from high-side voltage of the sustain pulse applied to the scan electrode in the sustain period, and
third voltage is assumed to be voltage derived by subtracting low-side voltage of an address pulse applied to the data electrode from low-side voltage of a scan pulse applied to the scan electrode in the address period,
the driver circuit sets that voltage derived by subtracting the third voltage from the first voltage is not lower than a discharge start voltage where the data electrode is used as a positive electrode and the scan electrode is used as a negative electrode, and
the driver circuit sets that voltage derived by subtracting the third voltage from the second voltage does not exceed the sum of a discharge start voltage where the data electrode is used as a positive electrode and the scan electrode is used as a negative electrode, and a discharge start voltage where the data electrode is used as a negative electrode and the scan electrode is used as a positive electrode.

5. A driving method for a plasma display panel comprising:
driving a plasma display panel having a plurality of discharge cells each of which has a scan electrode, a sustain electrode, and a data electrode,
wherein each of a plurality of fields is formed using a plurality of subfields, each subfield having an address period in which address discharge is caused by applying a scan pulse to the scan electrode and applying an address pulse to the data electrode, a sustain period in which sustain discharge is caused by alternately applying a sustain pulse corresponding to luminance weight to the scan electrode and the sustain electrode, and an erasing period in which erasing discharge is caused by applying a predetermined voltage to the scan electrode and the sustain electrode,
wherein, in the erasing period, erasing discharge is selectively caused only in a discharge cell that has undergone address discharge in an immediately preceding address period, and
wherein the plurality of fields includes a first field in which a scan pulse is sequentially applied to the plurality of arranged scan electrodes in the order from one-side scan electrode to the-other-side scan electrode in the address period of a subfield with the lowest luminance weight, and a second field in which a scan pulse is sequentially applied to the plurality of arranged scan electrodes in the order from the the-other-side scan electrode to the one-side scan electrode in the address period of the subfield with the lowest luminance weight.

6. The driving method for the plasma display panel of claim 5, wherein
the first field and the second field are used alternately.

7. A plasma display apparatus comprising:
a plasma display panel having a plurality of discharge cells each of which has a scan electrode, a sustain electrode, and a data electrode; and
a driver circuit that forms one field using a plurality of subfields, each subfield having an address period in which address discharge is caused by applying a scan pulse to the scan electrode and applying an address pulse to the data electrode, a sustain period in which sustain discharge is caused by alternately applying a sustain pulse corresponding to luminance weight to the scan electrode and the sustain electrode, and an erasing period in which erasing discharge is caused by applying a predetermined voltage to the scan electrode and the sustain electrode, generates a driving voltage waveform, and applies the driving voltage waveform to each electrode of the plasma display panel,
wherein the driver circuit, in the erasing period, drives the plasma display panel by selectively causing erasing discharge only in a discharge cell that has undergone address discharge in an immediately preceding address period, and
wherein the plurality of fields includes a first field in which a scan pulse is sequentially applied to the plurality of arranged scan electrodes in the order from one-side scan electrode to the-other-side scan electrode in the address period of a subfield with the lowest luminance weight, and a second field in which a scan pulse is sequentially applied to the plurality of arranged scan electrodes in the order from the the-other-side scan electrode to the one-side scan electrode in the address period of the subfield with the lowest luminance weight.
